(19) United States
(12) Patent Application Publication
(10) Pub. No.: US 2017/0005373 A1
(43) Pub. Date: Jan. 5, 2017

(54) BATTERY SYSTEM

(71) Applicant: TOYOTA JIDOSHA KABUSHIKI KAISHA, Toyota-shi, Aichi-ken (JP)

(72) Inventor: Hiroki TASHIRO, Aichi-gun,Aichi-ken (JP)

(73) Assignee: TOYOTA JIDOSHA KABUSHIKI KAISHA, Toyota-shi, Aichi-ken (JP)

(21) Appl. No.: 15/106,092

(22) PCT Filed: Dec. 16, 2014
(86) PCT No.: PCT/IB2014/002793

§ 371 Date: Jun. 17, 2016

(30) Foreign Application Priority Data
Dec. 27, 2013 (JP) 2013-272547

(51) Int. Cl. H01M 10/48; H01M 2/10

(52) U.S. Cl. CPC H01M 10/484; H01M 10/486; H01M 2/1077; H01M 2220/20; H01M 2010/4271

(57) ABSTRACT

A battery system includes a secondary battery, a current sensor and a controller. The controller is configured to calculate a liquid level height of an electrolytic solution from a current value that is obtained by the current sensor. The controller is configured to calculate a flow rate of the electrolytic solution, a diffused state of salt in the electrolytic solution and an amount of salt produced in the electrolytic solution as a result of charging or discharging of a power generating element of the secondary battery on the basis of an amount of fluctuations in the liquid level height, and is configured to calculate a distribution of salt concentration on electrodes of the power generating element. The controller is configured to calculate an amount of increase in resistance of the secondary battery from the distribution of salt concentration.

### BACKGROUND OF THE INVENTION

1. Field of the Invention

The invention relates to a battery system that calculates the amount of increase in resistance at the time when an internal resistance value of a secondary battery increases with a bias of salt concentration in an electrolytic solution.

2. Description of Related Art

As described in Japanese Patent Application Publication No. 2010-060406 (JP 2010-060406 A), there is known that, when charging and discharging of a secondary battery are repeated at a large current, a bias of salt concentration is developed in an electrolytic solution and, as a result, the internal resistance value of the secondary battery increases. This increase in internal resistance value is distinguished from an increase in internal resistance value resulting from aged degradation of the secondary battery. In JP 2010-060406 A, with regard to the salt concentration in the electrolytic solution, the internal resistance value of the secondary battery increases with an increase in a difference in salt concentration in a direction in which a negative electrode and a positive electrode face each other.

### SUMMARY OF THE INVENTION

The electrolytic solution of the secondary battery is divided into an electrolytic solution between a negative electrode plate and a positive electrode plate that constitute a power generating element (in other words, inside the power generating element) and an electrolytic solution inside a battery case accommodating the power generating element and outside the power generating element. The increase in internal resistance value resulting from a bias of salt concentration is, found to depend on fluctuations in the liquid level of the electrolytic solution outside the power generating element. Thus, in acquiring an increase in internal resistance value, resulting from a bias of salt concentration, it is required to acquire fluctuations in the liquid level of the electrolytic solution outside the power generating element.

An aspect of the invention provides a battery system. The battery system includes a secondary battery, a current sensor and a controller. The secondary battery includes a power generating element, an electrolytic solution and a battery case. The power generating element is configured to be charged or discharged. The power generating element and the electrolytic solution are accommodated in the battery case. The electrolytic solution is inside the power generating element and outside the power generating element. The current sensor is configured to detect a current value of the secondary battery.

The controller is configured to calculate a liquid level height of the electrolytic solution. The liquid level height indicates a height of a liquid level of the electrolytic solution outside the power generating element with a height from a reference plane to a reference point of the liquid level. The liquid level height is calculated on the basis of the current value that is detected by the current sensor. The controller is configured to calculate a first flow rate. The first flow rate is a flow rate at the time when the electrolytic solution moves from an inside of the power generating element toward an outside of the power generating element. The first flow rate is calculated at each position within the power generating element in a moving direction of the electrolytic solution on the basis of an amount of fluctuations in the liquid level height when the liquid level height fluctuates in a direction in which the reference point moves away from a non-fluctuating liquid level. The controller is configured to calculate a second flow rate. The second flow, rate is a flow rate at the time when the electrolytic solution moves from the outside of the power generating element toward the inside of the power generating element. The second flow rate is calculated at each position within the power generating element in the moving direction of the electrolytic solution on the basis of the amount of fluctuations in the liquid level height when the liquid level height fluctuates in a direction in which the reference point approaches the non-fluctuating liquid level. The controller is configured to calculate a distribution of salt concentration on a surface associated with charging or discharging in electrode plates that constitute the power generating element. The distribution of salt concentration is calculated on the basis of the first flow rate at each position, the second flow rate at each position, a diffused state of salt in the electrolytic solution and an amount of salt produced in the electrolytic solution as a result of charging or discharging of the power generating element. The controller is configured to calculate an amount of increase in resistance of the secondary battery. The amount of increase in resistance is an amount of increase in an internal resistance value at the time when the internal resistance value of the secondary battery increases with a bias of salt concentration in the electrolytic solution. The amount of increase in resistance is an amount of increase in resistance corresponding to a maximum difference in the salt concentration, which is identified from the distribution of salt concentration.

When the secondary battery is charged or discharged, the electrolytic solution inside the power generating element can move along the surface of each electrode plate. Because of the movement of the electrolytic solution, it is presumable that a bias of salt concentration is developed on the surface of each electrode plate and, as a result, the internal resistance value of the secondary battery increases. When the electrolytic solution moves along the surface of each electrode plate, the electrolytic solution moves between the inside and outside of the power generating element. As a result, in the electrolytic solution outside the power generating element, the liquid level height fluctuates. In the above aspect, the distribution of salt concentration by focusing on the amount of fluctuations in the liquid level height, and the amount of increase in resistance is calculated on the basis of the maximum difference in salt concentration, which is identified from the distribution of salt concentration.

Because the liquid level height depends on the current value at the time when the secondary battery is charged or discharged, it is possible to calculate the liquid level height when the current value is detected. When the liquid level height is calculated in this, way, it is possible to acquire fluctuations in the liquid level height. When the electrolytic solution moves from the inside of the power generating element toward the outside of the power generating element, the liquid level height fluctuates in the direction in which the reference point moves away from the non-fluctuating liquid level. Therefore, in the moving direction of the electrolytic solution, it is possible to calculate the flow rate of the electrolytic solution. Because the flow rate of the electrolytic solution depends on the amount of fluctuations in the liquid level height, it is possible to calculate the flow rate on the basis of the amount of fluctuations in the liquid level height. The flow rate of the electrolytic solution is not constant over all the positions within the power generating element, and varies with the position within the power generating element. Thus, it is required to calculate the flow rate at each position within the power generating element.

When the electrolytic solution moves from the outside of the power generating element toward the inside of the power generating element, the liquid level height fluctuates in the direction in which the reference point approaches the non-fluctuating liquid level. Therefore, in the moving direction of the electrolytic solution, it is possible to calculate the flow rate of the electrolytic solution. Because the flow rate of the electrolytic solution depends on the amount of fluctuations in the liquid level height, it is possible to calculate the flow rate on the basis of the amount of fluctuations in the liquid level height. In this case as well, as described above, it is required to calculate the flow rate at each position within the power generating element. By calculating the flow rate in this way, it is possible to acquire the distribution of salt concentration on the surface of each electrode plate, and it is possible to acquire the amount of increase in resistance from the distribution of salt concentration (the maximum difference in the salt concentration).

The liquid level height tends to depend on not only the current value but also a state of charge (SOC) or temperature of the secondary battery. It is possible to calculate the liquid level height in consideration of not only the current value but also at least one of the SOC or the temperature. For example, in the above aspect, the controller may be configured to calculate the SOC of the secondary battery, and may be configured to calculate the liquid level height on the basis of the SOC and the current value. In the above aspect, the battery system may further include a temperature sensor. The temperature sensor may be configured to detect a temperature of the secondary battery. The controller may be configured to calculate the liquid level height by using at least one of the temperature or the SOC. When a correlation among the current value, at least one of the SOC or the temperature and the liquid level height is obtained in advance, it is possible to calculate the liquid level height.

Because the liquid level height is calculated at intervals of the predetermined time, the amount of fluctuations in the liquid level height within the predetermined time is calculated. When the amount of fluctuations is added to the last liquid level height, it is possible to calculate the current liquid level height after a lapse of the predetermined time. When the liquid level height reaches the limit value within the predetermined time, it is possible to calculate the amount of fluctuations in the liquid level height on the basis of the limit value. However, there is a case where the liquid level height does not reach the limit value within the predetermined time. In this case, by adding the amount of fluctuations in the liquid level height within the predetermined time to the last liquid level height, it is possible to calculate the current liquid level height.

In the above aspect, the controller may be configured to acquire information about at least one of a state of charge of the secondary battery or a temperature of the secondary battery. The controller may be configured to calculate the limit value corresponding to the current value that is detected by the current sensor and the acquired information by using a correlation among the current value, the information and the limit value.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that shows the configuration of a battery system;

FIG. 2 is a view that shows the configuration of a secondary battery;

FIG. 3 is an expansion plan of a power generating element;

FIG. 4 is an external appearance view of the power generating element;

FIG. 5 is a view that illustrates a bias of salt concentration in a direction in which a negative electrode plate and a positive electrode plate face each other;

FIG. 6 is a view that illustrates a bias of salt concentration on the surfaces of the negative electrode plate and positive electrode plate;

FIG. 7 is a view that illustrates fluctuations in the liquid level of an electrolytic solution;

FIG. 8 is a flowchart that illustrates the process of calculating the amount of increase in resistance;

FIG. 9 is a graph that shows the correlation between an upper limit value and a current value;

FIG. 10 is a graph that illustrates the amount of fluctuations in liquid level height;

FIG. 11 is a graph that illustrates the amount of fluctuations in liquid level height;

FIG. 12 is a view that illustrates a positional relationship in a region A;

FIG. 13 is a graph that illustrates the correlation between a flow rate and a distance;

FIG. 14 is, a graph that shows the correlation between an amount of increase in resistance and a difference in salt concentration;

FIG. 15 is a flowchart that illustrates the process of calculating the amount of increase in resistance.

FIG. 16 is a graph that illustrates the correlation between a flow rate and a distance; and

FIG. 17 is a flowchart that illustrates the process of charging or discharging a secondary battery.

### DETAILED DESCRIPTION OF EMBODIMENTS

Hereinafter, an embodiment of the invention will be described.

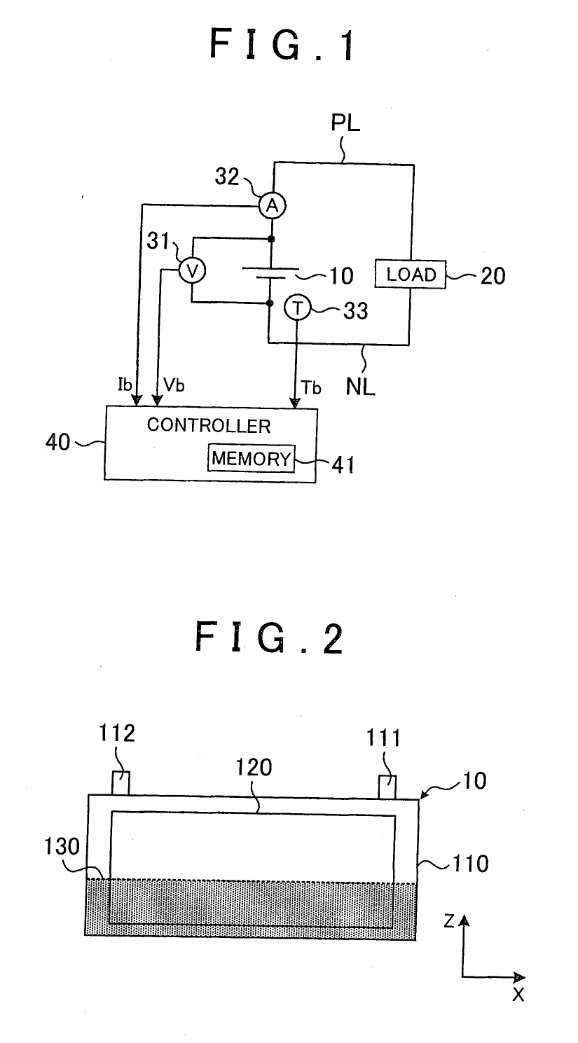

A battery system according to the invention will be described with reference to FIG. 1. A secondary battery 10 is connected to a load 20 via a positive electrode line PL and a negative electrode line NL. The load 20 operates upon reception of electric power output from the secondary battery 10. The load 20 is able to generate electric power, and electric power generated by the load 20 is supplied to the secondary battery 10. Thus, the secondary battery 10 is charged.

The battery system shown in FIG. 1 may be, for example, mounted on a vehicle. In this case, a battery pack in which a plurality of the secondary batteries 10 are connected in series may be mounted on a vehicle. A motor generator may be used as the load 20. The motor generator is able to generate power for propelling the vehicle upon reception of electric power output from the secondary battery 10. The power generated by the motor generator is transmitted to a wheel. The motor generator is able to convert kinetic energy, which is generated during braking of the vehicle, to electric power and supply the electric power to the secondary battery 10.

A voltage sensor 31 detects the voltage value Vb of the secondary battery 10, and outputs the detected result to a controller 40. A current sensor 32 detects the current value Ib of the secondary battery 10, and outputs the detected result to the controller 40. In the present embodiment, the current value Ib is a positive value when the secondary battery 10 is discharged, and the current value Ib is a negative value when the secondary battery 10 is charged.

A temperature sensor 33 detects the temperature Tb of the secondary battery 10, and outputs the detected result to the controller 40. The controller 40 includes a memory 41. The memory 41 stores information that is used when the controller 40 executes a predetermined process (particularly, a process that will be described in the present embodiment). The memory 41 may be provided outside the controller 40.

Next, the structure of the secondary battery 10 will be described with reference to FIG. 2. In FIG. 2, an X axis and a Z axis are axes that are perpendicular to each other. In the present embodiment, an axis corresponding to a vertical direction is set as the Z axis. An axis that is perpendicular to the X axis and the Z axis is set as a Y axis.

The secondary battery 10 includes a battery case 110 and a power generating element 120. The battery case 110 accommodates the power generating element 120. The battery case 110 is in a hermetically sealed state. An electrolytic solution 130 is contained inside the battery case 110. A negative electrode terminal 111 and a positive electrode terminal 112 are fixed to the battery case 110. The negative electrode terminal 111 and the positive electrode terminal 112 are electrically connected to the power generating element 120.

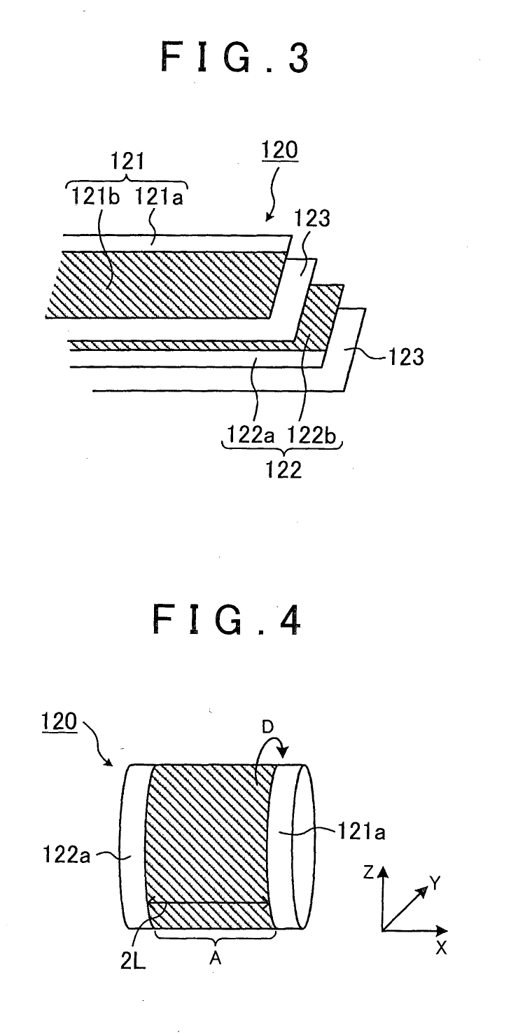

The power generating element 120 is an element that is charged or discharged, and includes a negative electrode plate (electrode plate) 121, a positive electrode plate (electrode plate) 122 and a separator 123, as shown in FIG. 3. FIG. 3 is an expansion plan of the power generating element 120. The negative electrode plate 121 includes a current collector foil 121a and a negative electrode active material layer 121b. The negative electrode active material layer 121b is formed on the surface of the current collector foil 121a. The negative electrode active material layer 121b includes a negative electrode active material, a conductive agent, a binder, and the like. The negative electrode active material layer 121b is formed in part of the region of the current collector foil 121a, and no negative electrode active material layer 121b is formed in the remaining region of the current collector foil 121a.

The positive electrode plate 122 includes a current collector foil 122a and a positive electrode active material layer 122b. The positive electrode active material layer 122b is formed on the surface of the current collector foil 122a. The positive electrode active material layer 122b includes a positive electrode active material, a conductive agent, a binder, and the like. The positive electrode active material layer 122b is formed in part of the region of the current collector foil 122a, and no positive electrode active material layer 122b is formed in the remaining region of the current collector foil 122a.

The negative electrode active material layer 121b, the positive electrode active material layer 122b and the separator 123 are impregnated with the electrolytic solution 130. The electrolytic solution 130 is inside the power generating element 120. On the other hand, as shown in FIG. 2, there is also the electrolytic solution 130 as a redundant solution outside the power generating element 120, that is, a space formed between the power generating element 120 and the battery case 110.

In the order shown in FIG. 3, the negative electrode plate 121, the positive electrode plate 122 and the separator 123 are stacked, and the stacked structure is rolled in an arrow D direction shown in FIG. 4 around the X axis. Thus, the power generating element 120 is formed. The separator 123 is arranged between the negative electrode plate 121 and the positive electrode plate 122.

At one end of the power generating element 120 in a direction in which the X axis extends (referred to as X direction), only the current collector foil 121a of the negative electrode plate 121 is rolled. The portion in which only the current collector foil 121a is rolled is electrically connected to the negative electrode terminal 111 shown in FIG. 2. At the other end of the power generating element 120 in the X direction, only the current collector foil 122a of the positive electrode plate 122 is rolled. The portion in which only the current collector foil 122a is rolled is electrically connected to the positive electrode terminal 112 shown in FIG. 2.

In the present embodiment, as described above, the power generating element 120 is formed by rolling the stacked structure; however, the power generating element 120 is not limited to this configuration. Specifically, the power generating element 120 may also be formed only by stacking the negative electrode plate 121, the positive electrode plate 122 and the separator 123 without rolling the stacked structure.

The region A shown in FIG. 4 is a region in which the negative electrode active material layer 121b and the positive electrode active material layer 122b face each other. In the region A, a chemical reaction according to charging or discharging of the secondary battery 10 (power generating element 120) occurs. That is, the region A is a region associated with charging or discharging of the secondary battery 10 (power generating element 120). The length of the region A in the X direction is set to 2L.

In the secondary battery 10, because of development of a bias of salt concentration in the electrolytic solution 130, the internal resistance value of the secondary battery 10 increases. Such an amount of increase in internal resistance value is denoted by an amount of increase in resistance Dh. The amount of increase in resistance Dh differs from the amount of increase in internal resistance value, resulting from degradation of the secondary battery 10. The amount of increase in internal resistance value, resulting from degradation, just increases, and does not decrease. On the other hand, because the amount of increase in resistance Dh depends on a bias of salt concentration, the amount of increase in resistance Dh increases as a bias of salt concentration increases; whereas the amount of increase in resistance Dh decreases as a bias of salt concentration decreases.

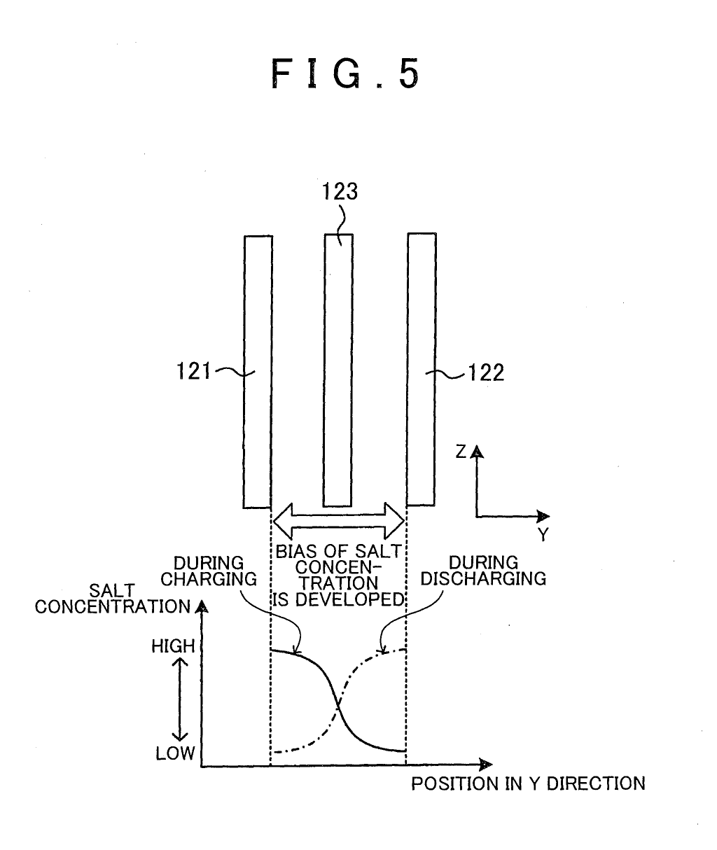

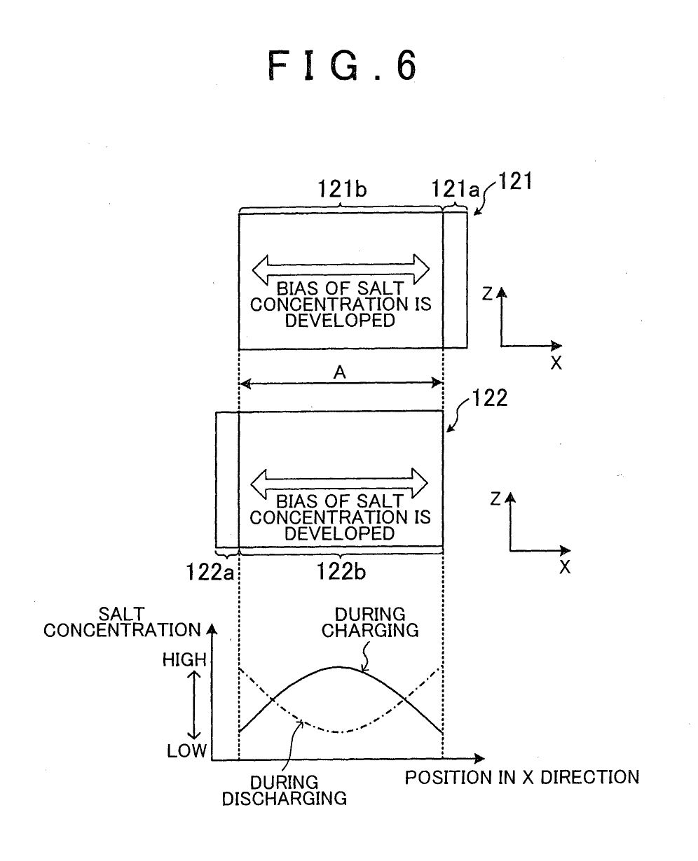

The state of bias of salt concentration includes the state shown in FIG. 5 and the state shown in FIG. 6. FIG. 5 shows a state where there occurs a bias of salt concentration in a direction in which the negative electrode plate 121 and the positive electrode plate 122 face each other (Y direction). FIG. 5 shows a schematic view (upper-side view of FIG. 5) showing the positional relationship among the negative electrode plate 121, the positive electrode plate 122 and the separator 123, and shows a view (lower-side view of FIG. 5) showing (an example of) a distribution of salt concentration. In the view showing the distribution of salt concentration, the ordinate axis represents salt concentration, and the abscissa axis represents position in the Y direction. In FIG. 5 (upper-side view), the negative electrode plate 121 and the positive electrode plate 122 are located apart from the separator 123; however, actually, the negative electrode plate 121 and the positive electrode plate 122 are in contact with the separator 123. As shown in FIG. 5 (lower-side view), during charging of the secondary battery 10, the distribution of salt concentration, indicated by the continuous line, is developed as a bias of salt concentration. During discharging of the secondary battery 10, the distribution of salt concentration, indicated by the alternate long and short dashed line, is developed as a bias of salt concentration.

FIG. 5 shows a bias of salt concentration in the Y direction; however, a bias of salt concentration is not limited to this direction. As described above, in the power generating element 120 according to the present embodiment, because the negative electrode plate 121 and the positive electrode plate 122 are rolled around the X axis, a bias of salt concentration is developed in a direction in which the negative electrode plate 121 (negative electrode active material layer 121b) and the positive electrode plate 122 (positive electrode active material layer 122b) face each other.

When the secondary battery 10 is charged or discharged, salt moves between the negative electrode plate 121 and the positive electrode plate 122 in the direction in which the negative electrode plate 121 and the positive electrode plate 122 face each other. When the secondary battery 10 is a lithium ion secondary battery, this salt is a lithium salt. The salt moves in the direction in which the negative electrode plate 121 and the positive electrode plate 122 face each other, with the result that a bias of salt concentration is developed in the direction in which the negative electrode plate 121 and the positive electrode plate 122 face each other.

FIG. 6 shows a state where a bias of salt concentration is developed on the respective surfaces (on the region A) of the negative electrode plate 121 and positive electrode plate 122. FIG. 6 shows part of the negative electrode plate 121 including the region A and part of the positive electrode plate 122 including the region A separately one above the other. As indicated by the arrows in FIG. 6, a bias of salt concentration is easy to be developed in the X direction within the region A. FIG. 6 also shows (an example of) the distribution of salt concentration within the region A in each of the negative electrode plate 121 and the positive electrode plate 122. In the view showing the distribution of salt concentration, the ordinate axis represents salt concentration, and the abscissa axis represents position in the X direction. During charging of the secondary battery 10, the distribution of salt concentration, indicated by the continuous line, is developed as a bias of salt concentration. During discharging of the secondary battery 10, the distribution of salt concentration, indicated by the alternate long and short dashed line, is developed as a bias of salt concentration.

As described above, at each end of the power generating element 120 in the X direction, the negative electrode plate 121 (current collector foil 121a) or the positive electrode plate 122 (current collector foil 122a) is just rolled around the X axis. Therefore, at each end of the power generating element 120 in the X direction, the electrolytic solution 130 is easy to pass through. In other words, the electrolytic solution 130 is easy to move from the inside of the power generating element 120 toward the outside of the power generating element 120 or the electrolytic solution 130 is easy to move from the outside of the power generating element 120 toward the inside of the power generating element 120.

Thus, as shown in FIG. 6, a bias of salt concentration is easy to be developed in the X direction within the region A. As described above, even with the configuration that the negative electrode plate 121, the positive electrode plate 122 and the separator 123 are just stacked, the electrolytic solution 130 is easy to move from the inside of the power generating element 120 toward the outside of the power generating element 120 or the electrolytic solution 130 is easy to move from the outside of the power generating element 120 toward the inside of the power generating element 120.

When a bias of salt concentration, shown in FIG. 5, is developed, salt moves along the respective surfaces of the negative electrode plate 121 and positive electrode plate 122. Accordingly, a bias of salt concentration, shown in FIG. 6, is developed. On the other hand, a bias of salt concentration, shown in FIG. 6, is developed by not only a bias of salt concentration, shown in FIG. 5, but also fluctuations in the liquid level of the electrolytic solution 130. In the present embodiment, with regard to the electrolytic solution (redundant solution) 130 outside the power generating element 120, attention is directed to the fluctuations in liquid level. When the secondary battery 10 is charged or discharged, the liquid level of the electrolytic solution 130 fluctuates. Because 20, of the fluctuations in liquid level, salt moves along the respective surfaces of the negative electrode plate 121 and positive electrode plate 122. Accordingly, a bias of salt concentration, shown in FIG. 6, is developed.

The distance between the facing negative electrode plate 121 and positive electrode plate 122 (for example, the distance in the Y direction shown in FIG. 5) is shorter than the length L of the region A in the X direction. Therefore, a bias of salt concentration, shown in FIG. 5, is easy to be reduced. Thus, a bias of salt concentration, shown in FIG. 6, tends to depend on fluctuations in liquid level. Therefore, in the present embodiment, fluctuations in liquid level are acquired, and a bias of salt concentration (the distribution of salt concentration) shown in FIG. 6 is acquired. When a bias of salt concentration, shown in FIG. 6, is acquired, it is possible to acquire the amount of increase in resistance Dh.

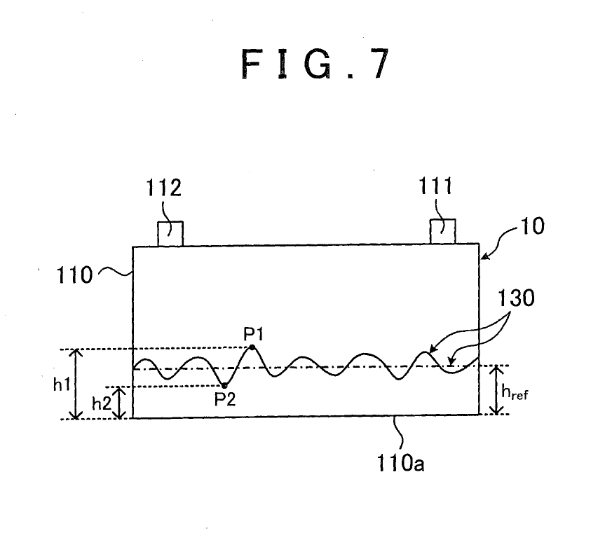

Fluctuations in the liquid level of the electrolytic solution 130 depend on the current value (absolute value) Ib. When the secondary battery 10 is not charged or discharged, in other words, when the current value Ib is 0 [A], the liquid level of the electrolytic solution 130 does not fluctuate, and the liquid level is in a state along a horizontal plane (X-Y plane) as indicated by the alternate long and short dashed line in FIG. 7. The liquid level indicated by the alternate long and short dashed line in FIG. 7 is the liquid level of the electrolytic solution (redundant solution) 130 outside the power generating element 120. At this time, the height of the liquid level of the electrolytic solution 130 is a liquid level height h_{ref}. The liquid level height h_{ref} is a height from the bottom face (which corresponds to a reference plane according to the invention) 110a of the battery case 110 to the liquid level of the electrolytic solution 130.

On the other hand, when charge current or discharge current flows through the secondary battery 10 and the current value (absolute value) Ib becomes larger than 0 [A], the liquid level of the electrolytic solution 130 fluctuates. Thus, as indicated by the continuous line in FIG. 7, the liquid level of the electrolytic solution 130 has a wavy shape. The liquid level indicated by the continuous line in FIG. 7 is the liquid level of the electrolytic solution (redundant solution) 130 outside the power generating element 120. Fluctuations in the liquid level of the electrolytic solution (redundant solution) 130 are considered to occur as a result of movement of the electrolytic solution 130 between the inside and outside of the power generating element 120. A height (maximum height) from the bottom face 110a to a highest peak (which corresponds to a reference point according to the invention) P1 within the liquid level of the electrolytic solution 130 is defined as liquid level height h1. The liquid level height h1 at the time when the liquid level is fluctuating is higher than, the liquid level height h_{ref}. The liquid level height h1 at the time when the liquid level is not fluctuating is equal to the liquid level height h_{ref}.

When current (charge current or discharge current) continuously flows through the secondary battery 10 at any current value (absolute value) Ib larger than 0 [A], the liquid level height h1 becomes difficult to fluctuate. The liquid level height h1 at this time is defined as an upper limit value (which corresponds to a limit value according to the invention) hₘₐₓ. In a state where no current flows through the secondary battery 10, when current continuously flows through the secondary battery 10 at any current value (absolute value) Ib, the liquid level height h1 fluctuates from the liquid level height h_{ref} to the upper limit value hₘₐₓ. The upper limit value hₘₐₓ depends on the current value (absolute value) Ib. Specifically, as the current value (absolute value) Ib increases, the upper limit value hₘₐₓ increases. In other words, as the current value (absolute value) Ib decreases, the upper limit value hₘₐₓ decreases.

When the liquid level height h1 keeps being monitored, it is possible to acquire fluctuations in the liquid level height h1 (that is, fluctuations in the liquid level of the electrolytic solution 130). Thus, it is possible to acquire the amount of increase in resistance Dh by acquiring a bias of salt concentration, shown in FIG. 6.

In the present embodiment, the height (maximum height) from the bottom face 110a to the peak P1 is defined as the liquid level height h1; however, the liquid level height h1 is not limited to this configuration. Specifically, a height (minimum height) from the bottom face 110a to a lowest point P2 (which corresponds to the reference point according to the invention, and see FIG. 7) within the liquid level of the electrolytic solution 130 may be defined as a liquid level height h2. In this case as well, when the liquid level height (minimum height) h2 keeps being monitored, it is, possible to acquire fluctuations in the liquid level height h2 (that is, fluctuations in the liquid level of the electrolytic solution 130).

When the liquid level height h2 is monitored, a lower limit value (which corresponds to the limit value according to the invention) hₘᵢₙ may be used instead of the above-described upper limit value hₘₐₓ. As described above, when current (charge current or discharge current) continuously flows through the secondary battery 10 at any current value (absolute value) Ib larger than 0 [A], the liquid level height h2 becomes difficult to fluctuate. The liquid level height h2 at this time is the lower limit value hₘᵢₙ.

On the other hand, in the present embodiment, the height (maximum height) from the bottom face 110a to the peak P1 is defined as the liquid level height h1; however, the liquid level height h1 is not limited to this configuration. Specifically, a height (maximum height) from the liquid level height (which corresponds to the reference plane according to the invention) h_{ref} to the peak P1 may be defined as the liquid level height h1. That is, when the liquid level height h1 is defined, the bottom face 110a or the liquid level height h_{ref} may be set for a reference. When the liquid level height (minimum height) h2 is defined as well, the bottom face 110a or the liquid level height h_{ref} may be set for a reference.

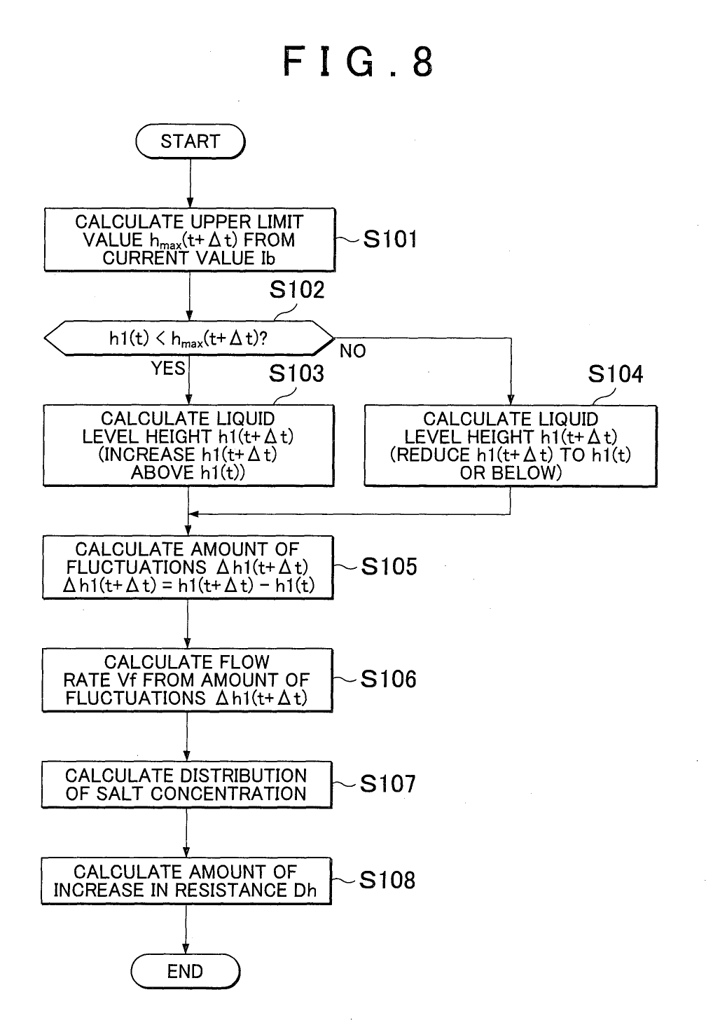

Next, the process of calculating the amount of increase in resistance Dh will be described with reference to the flowchart shown in FIG. 8. The process shown in FIG. 8 is repeatedly executed at intervals of a predetermined time Δt, and is executed by the controller 40.

In step S101, the controller 40 calculates an upper limit value hₘₐₓ(t+Δt) on the basis of the current value Ib of the secondary battery 10. “t” denotes last time, and “t+Δt” denotes current time.

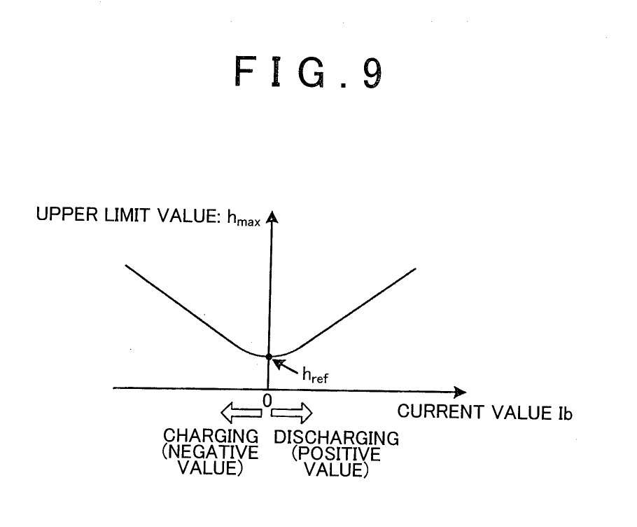

There is a correlation (one example) shown in FIG. 9 between an upper limit value hₘₐₓ and a current value Ib. In FIG. 9, the ordinate axis represents upper limit value hₘₐₓ, and the abscissa axis represents current value Ib. When the current value Ib is 0 [A], the liquid level of the electrolytic solution 130 does not fluctuate, so the upper limit value hₘₐₓ becomes the liquid level height h_{ref}. When the current value (absolute value) Ib is larger than 0 [A], the upper limit value hₘₐₓ becomes higher than the liquid level height h_{ref}. As the current value (absolute value) Ib becomes larger than 0 [A], the upper limit value hₘₐₓ increases, and the difference between the upper limit value hₘₐₓ and the liquid level height h_{ref} increases. In other words, as the current value (absolute value) Ib approaches 0 [A], the upper limit value hₘₐₓ decreases, and the difference between the upper limit value hₘₐₓ and the liquid level height h_{ref} decreases.

The correlation between an upper limit value hₘₐₓ and a current value Ib, shown in FIG. 9, may be obtained in advance by an experiment. Specifically, by preparing the secondary battery 10 including the transparent battery case 110, it is possible to measure the liquid level height h1. When the upper limit value hₘₐₓ is measured while the current value Ib is changed, it is possible to identify the correlation between a current value Ib and an upper limit value hₘₐₓ.

The correlation shown in FIG. 9 may be expressed as a map or an arithmetic expression. Information that identifies the correlation shown in FIG. 9 may be stored in the memory 41. When the current value Ib is detected by the current sensor 32, it is possible to calculate the upper limit value hₘₐₓ corresponding to the current value Ib.

In the present embodiment, the upper limit value hₘₐₓ is calculated on the basis of the current value Ib; however, calculation of the upper limit value hₘₐₓ is not limited to this configuration. The upper limit value hₘₐₓ can fluctuate depending on not only the current value Ib but also the temperature Tb or the state of charge (SOC) of the secondary battery 10. The upper limit value hₘₐₓ may be calculated on the basis of at least one of the temperature Tb or the SOC in addition to the current value Ib.

The SOC is the ratio of a current level of charge to a full charge capacity. The SOC of the secondary battery 10 may be calculated (estimated) by using a known method. For example, there is a predetermined correlation between an open circuit voltage (OCV) and SOC of the secondary battery 10. When the correlation is obtained in advance, it is possible to calculate the SOC corresponding to the OCV by detecting the OCV of the secondary battery 10. The OCV of the secondary battery 10 can be detected by the voltage sensor 31. On the other hand, by keeping accumulation of the current value Ib of the secondary battery 10, it is possible to calculate the SOC of the secondary battery 10.

When the correlation shown in FIG. 9 is obtained in advance while the temperature Tb is changed, it is possible to calculate the upper limit value hₘₐₓ on the basis of the current value Ib and the temperature Tb. The temperature Tb can be detected by a temperature sensor 33. When the correlation shown in FIG. 9 is obtained in advance while the SOC is changed, it is possible to calculate the upper limit value hₘₐₓ on the basis of the current value Ib and the SOC. In addition, when the correlation shown in FIG. 9 is obtained in advance for each temperature Tb and each SOC, it is possible to calculate the upper limit value hₘₐₓ on the basis of the current value Ib, the temperature Tb and the SOC.

In step S102, the controller 40 determines whether the liquid level height h1(t) is lower than the upper limit value hₘₐₓ(t+Δt) calculated in the process of step S101. The liquid level height h1(t) is the liquid level height h1 calculated in the last process (the process shown in FIG. 8).

When the liquid level height h1(t) is lower than the upper limit value hₘₐₓ(t+Δt), the controller 40 calculates the current liquid level height h1(t+Δt) in step S103. The liquid level height h1(t+Δt) is calculated on the basis of the following mathematical expression (1). The liquid level height h1(0) in the case where t is “0” is the liquid level height h_{ref}.

$$h 1 ( t + Δ t ) = h 1 ( t ) + [ {h}_{ma x} ( t + Δ t ) - {h}_{ref} ] \times \frac{Δ t}{{t}_{ma x 1}} \qquad ( 1 )$$

In the above mathematical expression (1), hₘₐₓ(t+Δt) is the upper limit value hₘₐₓ calculated in the process of step S101. At is a period (predetermined time) at intervals of which the process shown in FIG. 8 is executed. The liquid level height h_{ref} may be obtained in advance. For example, when the correlation between an amount (contained amount) of the electrolytic solution 130 that is contained in the battery case 110 and a liquid level height h_{ref} is obtained in advance, it is possible to identify the liquid level height h_{ref} from the contained amount of the electrolytic solution 130.

tₘₐₓ₁ is a time from when the liquid level height h1 is the liquid level height h_{ref} to when the liquid level height h1 reaches the upper limit value hₘₐₓ(t+Δt). The time tₘₐₓ₁ varies with the upper limit value h_{max.} Therefore, in the process of step S103, the time tₘₐₓ₁ to the upper limit value hₘₐₓ(t+Δt) calculated in the process of step S101 is used.

The correlation between a time tₘₐₓ₁ and an upper limit value hₘₐₓ may be obtained in advance by an experiment, or the like. Thus, by calculating the upper limit value hₘₐₓ, it is possible to calculate the time tₘₐₓ₁ corresponding to the upper limit value hₘₐₓ. The correlation between a time tₘₐₓ₁ and an upper limit value hₘₐₓ may be expressed as a map or an arithmetic expression. Information that identifies the correlation may be stored in the memory 41.

When the liquid level height h1(t) is lower than the upper limit value hₘₐₓ(t+Δt), the liquid level height h1 increases toward the upper limit value hₘₐₓ(t+Δt) during the predetermined time Δt. That is, the current liquid level height h1(t+Δt) becomes higher than the last liquid level height h1(t). Therefore, as shown in the above-described mathematical expression (1), by adding a value (positive value) at the second term on the right-hand side in the above-described mathematical expression (1) to the last liquid level height h1(t), the current liquid level height h1(t+Δt) is increased so as to be higher than the last liquid level height h1(t). When the liquid level height h1(t+Δt) becomes higher than the liquid level height h1(t), the peak P1 that defines the liquid level height h1 changes in a direction to move away from the liquid level of the non-fluctuating electrolytic solution (redundant solution) 130.

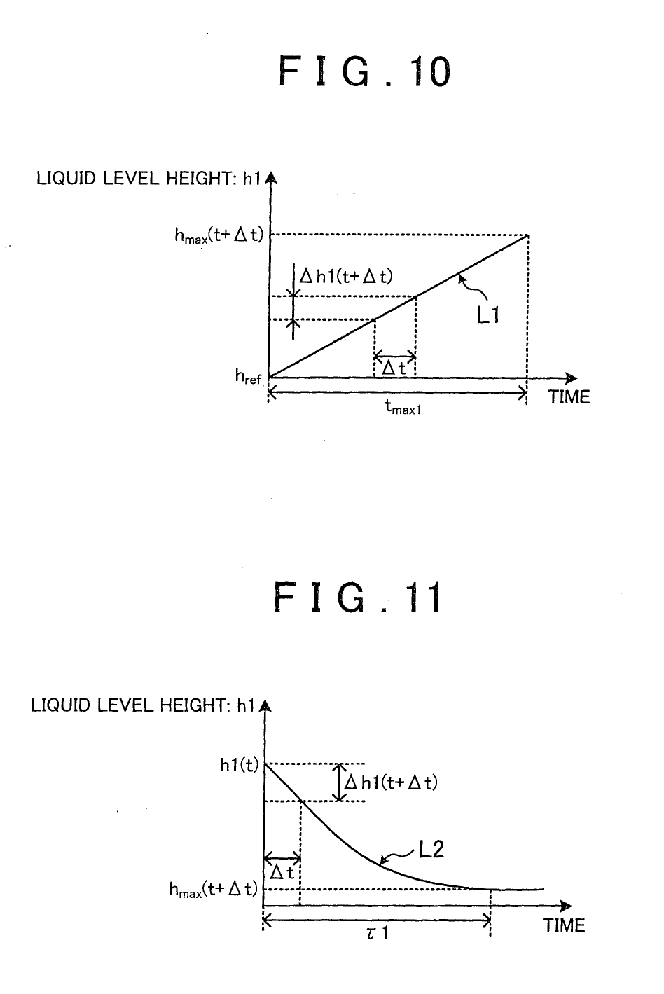

The amount of fluctuations (the amount of increase) in the liquid level height h1 during the predetermined time Δt is expressed by the second term on the right-hand side of the above-described mathematical expression (1). If the rate of increase in the liquid level height h1 is assumed to be constant, the liquid level height h1 increases at a constant amount of fluctuations the time tₘₐₓ₁ as indicated by the straight line L1 in FIG. 10. When the time tₘₐₓ₁ has elapsed, the liquid level height h1 reaches the upper limit value hₘₐₓ. During the predetermined time Δt, the amount of fluctuations in the liquid level height h1 becomes Δh1(t+Δt). As is apparent from FIG. 10, the amount of fluctuations Δh1(t+Δt) is expressed by the second term on the right-hand side in the above-described mathematical expression (1).

In the process of step S102, when the last liquid level height h1(t) is higher than or equal to the upper limit value hₘₐₓ(t+Δt), the controller 40 calculates the current liquid level height h1(t+Δt) in step S104. The liquid level height h1(t+Δt) is calculated on the basis of the following mathematical expression (2).

$$h 1 ( t + Δ t ) = h 1 ( t ) + [ {h}_{ma x} ( t + Δ t ) - h 1 ( t ) ] \times \frac{Δ t}{τ1} \qquad ( 2 )$$

In the above-described mathematical expression (2), τ1 is a time constant until fluctuations in the liquid level of the electrolytic solution 130 become stable. That is, τ1 is a time constant from when the liquid level height h1 is the liquid level height h1(t) to when the liquid level height h1 becomes the upper limit value hₘₐₓ(t+Δt). The time constant τ1 depends on the difference Δhₘₐₓ₁ between the liquid level height h1(t) and the upper limit value hₘₐₓ(t+Δt). Therefore, in the process of step S104, the time constant τ1 corresponding to the difference Δhₘₐₓ₁ between the upper limit value hₘₐₓ(t+Δt) and the liquid level height h1(t) is used. The upper limit value hₘₐₓ(t+Δt) is calculated in the process of step S101.

The correlation between a difference Δhₘₐₓ₁ and a time constant τ1 may be obtained in advance by an experiment, or the like. Thus, by calculating the difference Δhₘₐₓ₁, it is possible to calculate the time constant τ1 corresponding to the difference Δhₘₐₓ₁. The correlation between a time constant τ1 and a difference Δhₘₐₓ₁ may be expressed as a map or an arithmetic expression. Information that identifies the correlation may be stored in the memory 41.

When the liquid level height h1(t) is higher than or equal to the upper limit value hₘₐₓ(t+Δt), the liquid level height h1 remains at the upper limit value hₘₐₓ(t+Δt) or decreases toward the upper limit value hₘₐₓ(t+Δt) during the predetermined time Δt. That is, the current liquid level height h1(t+Δt) becomes lower than or equal to the last liquid level height h1(t). At the second term on the right-hand side in the above-described mathematical expression (2), the liquid level height h1(t) is subtracted from the upper limit value hₘₐₓ(t+Δt), so this, value becomes 0 or a negative value. In this way, by adding the value (0 or a negative value) at the second term on the right-hand side in the above-described mathematical expression (2) to the last liquid level height h1(t), the current liquid level height h1(t+Δt) is set so as to be lower than or equal to the last liquid level height h1(t). When the liquid level height h1(t+Δt) is lower than the liquid level height h1(t), the peak P1 that defines the liquid level height h1 changes in a direction to approach the liquid level of the non-fluctuating electrolytic solution (redundant solution) 130.

The amount of fluctuations (the amount of decrease) Δh1(t+Δt) in the liquid level height h1 during the predetermined time Δt is expressed by the second term on the right-hand side in the above-described mathematical expression (2). The amount of fluctuations Δh1(t+Δt) is calculated from the easement curve L2 shown in FIG. 11. The easement curve L2 indicates a locus of the liquid level height h1 from the liquid level height h1(t) to the upper limit value hₘₐₓ(t+Δt) with easement of fluctuations in the liquid level (decrease in the liquid level height h1). As is apparent from FIG. 11, the amount of fluctuations Δh1(t+Δt) during the predetermined time Δt is expressed by the second term on the right-hand side in the above-described mathematical expression (2).

In step S105, the controller 40 calculates the amount of fluctuations Δh1(t+Δt). The amount of fluctuations Δh1(t+Δt) is a value obtained by subtracting the last liquid level height h1(t) from the current liquid level height h1(t+Δt). The value calculated in the process of step S103 or step S104 is used as the liquid level height h1(t+Δt).

When the liquid level height h1(t+Δt) is set so as to be higher than the liquid level height h1(t) in the process of step S103, the amount of fluctuations Δh1(t+Δt) becomes a positive value. When the liquid level height h1(t+Δt) is set so as to be lower than or equal to the liquid level height h1(t) in the process of step S104, the amount of fluctuations Δh1(t+Δt) becomes 0 or a negative value.

In the process of step S103 or step S104, the amount of fluctuations Δh1(t+Δt) has been already calculated. Therefore, in the process of step S105, the amount of fluctuations Δh1(t+Δt) calculated in the process of step S103 or step S104 may be used. The value of the second term on the right-hand side in the above-described mathematical expression (1) or the value of the second term on the right-hand side in the above-described mathematical expression (2) becomes the amount of fluctuations Δh1(t+Δt).

In step S106, the controller 40 calculates a flow rate Vf from the amount of fluctuations Δh1(t+Δt) calculated in the process of step S105. The flow rate Vf is a flow rate at the time when the electrolytic solution 130 moves inside the power generating element 120 in accordance with the amount of fluctuations Δh1(t+Δt). The flow rate Vf may be calculated on the basis of the following mathematical expression (3).

$$Vf ( t + Δ t , d ) = Δ h 1 ( t + Δ t ) \times Vf\_fac \times \frac{d}{L} \qquad ( 3 )$$

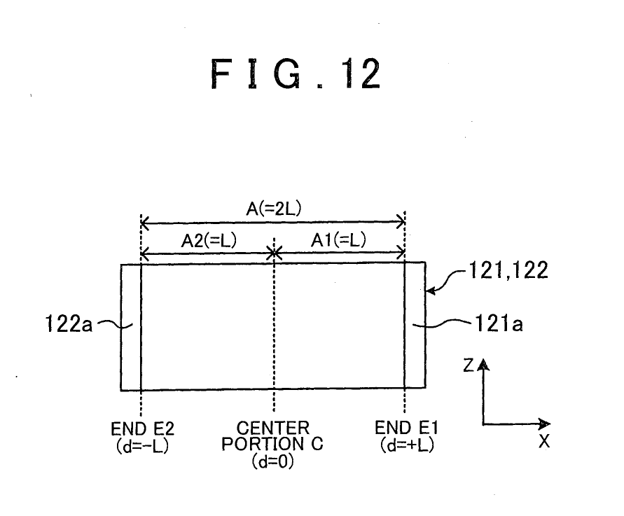

In the above-described mathematical expression (3), Vf_fac is a coefficient for converting the amount of fluctuations Δh1(t+Δt) to the flow rate Vf. d indicates a distance from the center portion C of the region A in the X direction (distance in the X direction) as shown in FIG. 12. FIG. 12 is an overlapped view of the negative electrode plate 121 and positive electrode plate 122 shown in FIG. 6. The distance d becomes “0” at the center portion C of the region A. The distance d is “+L” (positive value) at one end E1 of the region A in the X direction, and the distance d is “−L” (negative value) at the other end E2 of the region A in the X direction. The distance from the center portion C to the end E1 is equal to the distance from the center portion C to the end E2.

In FIG. 12, in a right-side region A1 with respect to the center portion C, the distance d changes within the range of 0 to “+L” in accordance with a position in the X direction. In a left-side region A2 with respect to the center portion C, the distance d changes within the range of 0 to “−L” in accordance with a position in the X direction. As shown in the above-described mathematical expression (3), the flow rate Vf is calculated at each position (distance d) within the region A in the X direction.

According to the above-described mathematical expression (3), the correlation between a distance d and a flow rate Vf becomes the correlation shown in FIG. 13. The straight line (continuous line) L3 shown in FIG. 13 indicates the correlation between a distance d and a flow rate Vf in the case where the amount of fluctuations Δh1(t+Δt) is a positive value. When the distance d is a negative value, the flow rate Vf becomes a negative value; however, the actual flow rate Vf becomes the absolute value of the flow rate (negative value) Vf. Therefore, the straight line L3 shown in FIG. 13 indicates that the flow rate Vf increases as the position approaches from the center portion C to one of the ends E1, E2. When the electrolytic solution 130 moves from the center portion C toward any one of the ends E1, E2, that is, when the electrolytic solution 130 moves from the inside of the power generating element 120 toward the outside of the power generating element 120, the liquid level height h1 increases. Accordingly, the amount of fluctuations Δh1(t+Δt) becomes a positive value. Therefore, the flow rate Vf in the straight line L3 is a flow rate at the time when the electrolytic solution 130 moves from the inside of the power generating element 120 toward the outside of the power generating element 120. The moving direction of the electrolytic solution 130 is the X direction.

The straight line (alternate long and short dashed line) IA shown in FIG. 13 indicates the correlation between a distance d and a flow rate Vf in the case where the amount of fluctuations Δh1(t+Δt) is a negative value. When the distance d is a positive value, the flow rate Vf becomes a negative value; however, the actual flow rate Vf becomes the absolute value of the flow rate (negative value) Vf. Therefore, the straight line L4 shown in FIG. 13 indicates that the flow rate Vf increases as the position approaches from the center portion C to one of the ends E1, E2. When the electrolytic solution 130 moves from one of the ends E1, E2 toward the center portion C, that is, when the electrolytic solution 130 moves from the outside of the power generating element 120 toward the inside of the power generating element 120, the liquid level height h1 decreases. Accordingly, the amount of fluctuations Δh1(t+Δt) becomes a negative value. Therefore, the flow rate Vf in the straight line L4 is a flow rate at the time when the electrolytic solution 130 moves from the outside of the power generating element 120 toward the inside of the power generating element 120. The moving direction of the electrolytic solution 130 is the X direction.

The electrolytic solution 130 at each of the ends E1, E2 adjoins to the electrolytic solution 130 outside the power generating element 120. Therefore, the amount of fluctuations in the electrolytic solution 130 at each of the ends E1, E2 is equal to the amount of fluctuations Δh1(t+Δt) in the electrolytic solution 130 outside the power generating element 120. Thus, the flow rate (absolute value) Vf at each of the ends E1, E2 becomes “Δh1(t+Δt)×Vf_fac”.

On the other hand, as the position shifts from one of the ends E1, E2 toward the center portion C, the electrolytic solution 130 becomes difficult to move. Therefore, as indicated by the straight lines L3, L4 in FIG. 13, the flow rate (absolute value) Vf decreases as the position shifts from one of the ends E1, E2 toward the center portion C. The flow rate Vf of the center portion C may be regarded as “0”.

In step S107, the controller 40 calculates the salt concentration on each of the surfaces of the negative electrode plate 121 and positive electrode plate 122 on the basis of the flow rate Vf calculated in the process of step S106. Specifically, the salt concentration is calculated on the basis of the following mathematical expression (4).

$$\frac{\partial ( {ɛ}_{ej} {c}_{ej} )}{\partial t} + Vf \cdot ∇ {ɛ}_{ej} {c}_{ej} = ∇ ( {D}_{ej}^{eff} ∇ {c}_{ej} ) + \frac{1 - {t}_{+}^{0}}{F} {j}_{j} \qquad ( 4 )$$

In the above mathematical expression (4), εₑⱼ is the volume fraction of the electrolytic solution 130, and cₑⱼ is the salt concentration in the electrolytic solution 130. The value calculated in the process of step S106 is used as the flow rate Vf. Dₑⱼ^{eff} is an active diffusion coefficient of the electrolytic solution 130, and t₊⁰ is a transport number of salt in the electrolytic solution 130. F is Faraday constant, and jⱼ is the amount of salt produced in the electrolytic solution 130 per unit volume and unit time. The suffixes are used to distinguish the negative electrode and the positive electrode from each other.

The first term on the left-hand side in the above-described mathematical expression (4) defines a change in the salt concentration during the predetermined time Δt. The second term on the left-hand side in the above-described mathematical expression (4) defines a change in the salt concentration, which depends on the flow (flow rate Vf) of the electrolytic solution 130. The first term on the right-hand side in the above-described mathematical expression (4) defines a diffused state of salt in the electrolytic solution 130. The second term on the right-hand side in the above-described mathematical expression (4) defines the amount of salt produced. During discharging of the secondary battery 10, salt is produced on the surface of the negative electrode plate 121; whereas, during charging of the secondary battery 10, salt is produced on the surface of the positive electrode plate 122.

By solving the above-described mathematical expression (4), it is possible to calculate the salt concentration cₑ on each of the surfaces of the negative electrode plate 121 and positive electrode plate 122. Because the flow rate Vf according to the distance d is used as the flow rate Vf, it is possible to calculate the salt concentration cₑ according to the distance d by solving the above-described mathematical expression (4).

Thus, it is possible to calculate the salt concentration cₑ according to the position (distance d) within the region A in the X direction. In other words, it is possible to calculate the distribution of salt concentration cₑ in the X direction. When the distribution of salt concentration cₑ is calculated, it is possible to calculate a difference (maximum difference) Δcₑ_{_}max in salt concentration cₑ. The difference Δcₑ_{_}max is the difference between the salt concentration (maximum value) cₑ and the salt concentration (minimum value) cₑ.

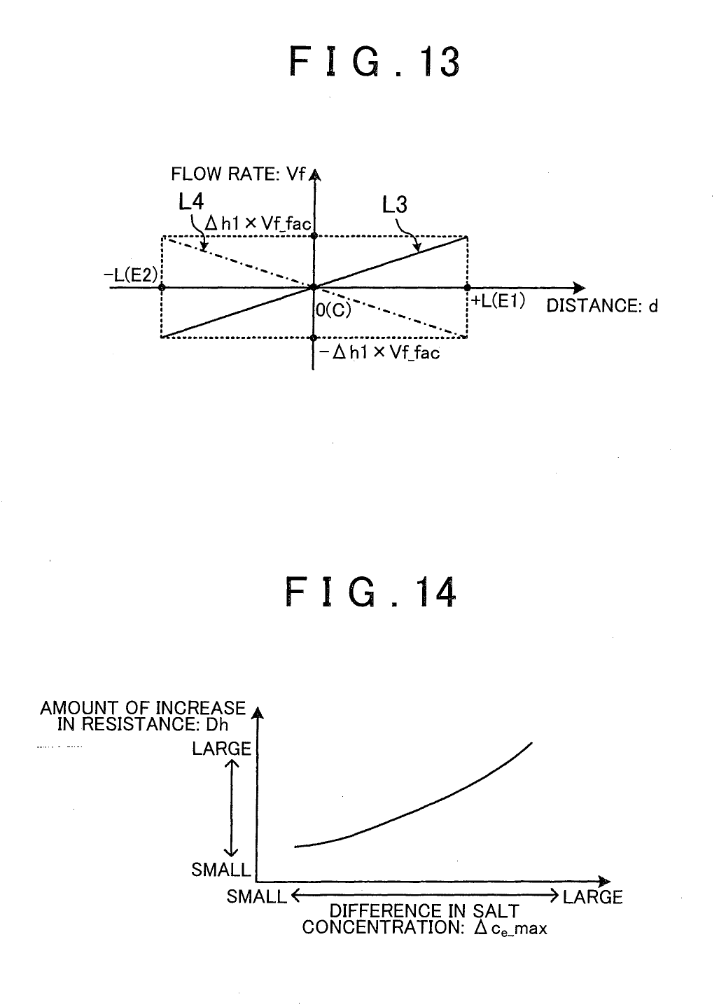

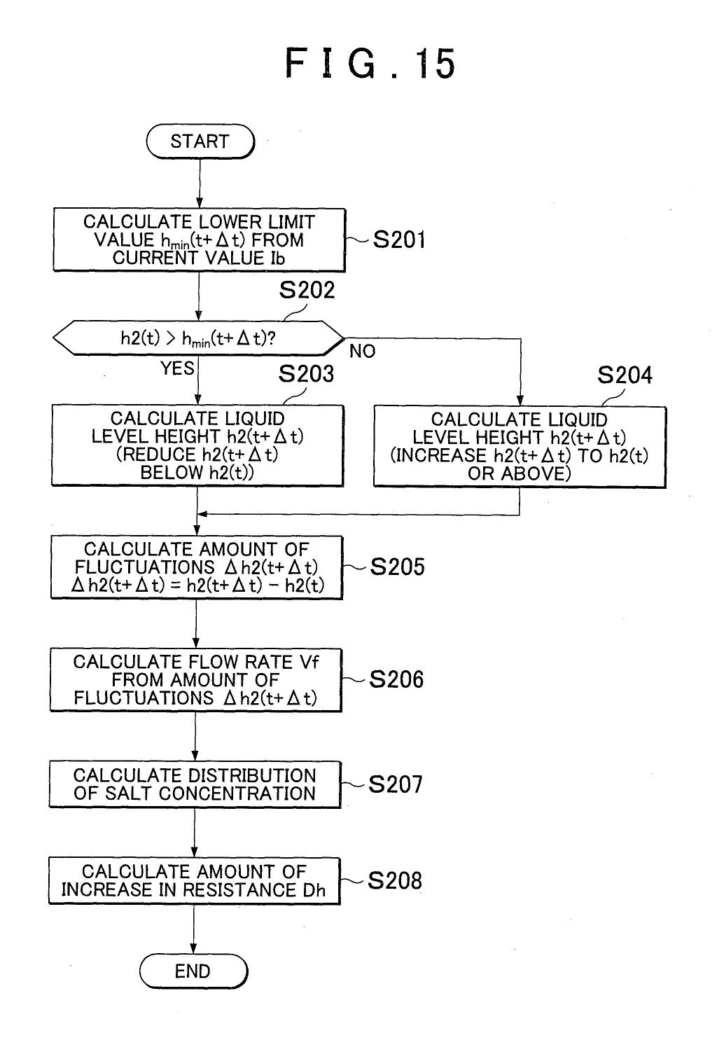

In step S108, the controller 40 calculates the amount of increase in resistance Dh. As shown in FIG. 14, when the correlation between an amount of increase in resistance Dh and a difference Δcₑ_{_}max in salt concentration cₑ is obtained in advance, it is possible to calculate the amount of increase in resistance Dh, corresponding to the difference Δcₑ_{_}max, by calculating the difference Δcₑ_{_}max. As shown in FIG. 14, as the difference Δcₑ_{_}max increases, the amount of increase in resistance Dh increases. In other words, as the difference Δcₑ_{_}max decreases, the amount of increase in resistance Dh decreases.

As described above, it is possible to calculate the difference Δcₑ_{_}max on the basis of the distribution of salt concentration cₑ, calculated in the process of step S107. The correlation between an amount of increase in resistance Dh and a difference Δcₑ_{_}max may be expressed as a map or an arithmetic expression. Information that identifies the correlation may be stored in the memory 41. In the process shown in FIG. 8, the amount of increase in resistance Dh is calculated each time the predetermined time Δt elapses. Accordingly, it is possible to acquire a change in the amount of increase in resistance Dh.

In the process shown in FIG. 8, the upper limit, value hₘₐₓ is calculated. However, as described above, the lower limit value hₘᵢₙ may be used instead of the upper limit value hₘₐₓ. In this case, the process of calculating the amount of increase in resistance Dh will be described with reference to the flowchart shown in FIG. 15. The process shown in FIG. 15 corresponds to the process shown in FIG. 8. Hereinafter, the process different from the process shown in FIG. 8 will be mainly described.

In step S201, the controller 40 calculates a lower limit value hₘᵢₙ(t+Δt) on the basis of the current value Ib of the secondary battery 10. The correlation between a lower limit value hₘᵢₙ and a current value Ib is inverse to the correlation (one example) shown in FIG. 9. That is, when the current value (absolute value) Ib is larger than 0 [A], the lower limit value hₘᵢₙ becomes lower than the liquid level height h_{ref}. As the current value (absolute value) Ib increases with respect to 0 [A], the difference between the lower limit value hₘᵢₙ and the liquid level height h_{ref} increases. In other words, as the current value (absolute value) Ib approaches 0 [A], the difference between the lower limit value hₘᵢₙ and the liquid level height h_{ref} decreases.

When the correlation between a lower limit value hₘᵢₙ and a current value Ib is obtained in advance, it is possible to calculate the lower limit value hₘᵢₙ corresponding to the current value Ib by detecting the current value Ib. The lower limit value hₘᵢₙ may be calculated on the basis of not only the current value Ib but also at least one of the temperature Tb or the SOC. In this case, the correlation among a current value Ib, at least one of a temperature Tb or an SOC and a lower limit value hₘᵢₙ just needs to be obtained in advance.

In step S202, the controller 40 determines whether the last liquid level height h2(t) is higher than the lower limit value hₘᵢₙ(t+Δt) calculated in the process of step S201. When the liquid level height h2(t) is higher than the lower limit value hₘᵢₙ(t+Δt), the controller 40 calculates the current liquid level height h2(t+Δt) in step S203. The liquid level height h2(t+Δt) is calculated on the basis of the following mathematical expression (5).

$$h 2 ( t + Δ t ) = h 2 ( t ) + [ {h}_{m i n} ( t + Δ t ) - {h}_{ref} ] \times \frac{Δ t}{{t}_{ma x 2}} \qquad ( 5 )$$

In the above-described mathematical expression (5), hₘᵢₙ(t+Δt) is the lower limit value hₘᵢₙ calculated in the process of step S201. At is a period (predetermined time) at intervals of which the process shown in FIG. 15 is executed. tₘₐₓ₂ is a time from when the liquid level height h2 is the liquid level height h_{ref} to when the liquid level height h2 reaches the lower limit value hₘᵢₙ(t+Δt). The time tₘₐₓ₂ varies with the lower limit value hₘᵢₙ. Therefore, in the process of step S203, the time tₘₐₓ₂ corresponding to the lower limit value hₘᵢₙ(t+Δt) calculated in the process of step S201 is used. When the correlation between a time tₘₐₓ₂ and a lower limit value hₘᵢₙ is obtained in advance, it is possible to calculate the time tₘₐₓ₂ corresponding to the lower limit value hₘᵢₙ by calculating the lower limit value hₘᵢₙ.

When the liquid level height h2(t) is higher than the lower limit value hₘᵢₙ(t+Δt), the liquid level height h2 decreases toward the lower limit value hₘᵢₙ(t+Δt) during the predetermined time Δt. That is, the current liquid level height h2(t+Δt) becomes lower than the last liquid level height h2(t). At the second term on the right-hand side in the above-described mathematical expression (5), the lower limit value hₘᵢₙ(t+Δt) is lower than the liquid level height h_{ref}, so the value of the second term on the right-hand side becomes a negative value. Thus, according to the above-described mathematical expression (5), the current liquid level height h2(t+Δt) is set so as to be lower than the last liquid level height h2(t). When the liquid level height h2(t+Δt) becomes lower than the liquid level height h2(t), a point P2 that defines the liquid level height h2 changes in a direction away from the liquid level of the non-fluctuating electrolytic solution (redundant solution) 130.

The amount of fluctuations (the amount of decrease) in the liquid level height h2 during the predetermined time Δt is expressed by the second term on the right-hand side in the above-described mathematical expression (5). As in the case of the above-described mathematical expression (1), the rate of decrease in the liquid level height h2 is assumed to be constant.

When the last liquid level height h2(t) is lower than or equal to the lower limit value hₘᵢₙ(t+Δt) in the process of step S202, the controller 40 calculates the current liquid level height h2(t+Δt) in step S204. The liquid level height h2(t+Δt) is calculated on the basis of the following mathematical expression (6).

$$h 2 ( t + Δ t ) = h 2 ( t ) + [ {h}_{m i n} ( t + Δ t ) - h 2 ( t ) ] \times \frac{Δ t}{τ2} \qquad ( 6 )$$

In the above mathematical expression (6), τ2 is a time constant until fluctuations in the liquid level of the electrolytic solution 130 become stable. That is, τ2 is a time constant from when the liquid level height h2 is the liquid level height h2(t) to when the liquid level height h2 becomes the lower limit value hₘᵢₙ(t+Δt). The time constant τ2 depends on the difference Δhₘₐₓ₂ between the liquid level height h2(t) and the lower limit value hₘᵢₙ(t+Δt). Therefore, in the process of step S204, the time constant τ2 corresponding to the difference Δhₘₐₓ₂ between the lower limit value hₘᵢₙ(t+Δt) and the liquid level height h2(t) is used. The lower limit value hₘᵢₙ(t+Δt) is calculated in the process of step S201. When the correlation between a difference Δhₘₐₓ₂ and a time constant τ2 is obtained in advance, it is possible to calculate the time constant τ2 corresponding to the difference Δhₘₐₓ₂ by calculating the difference Δhₘₐₓ₂.

When the liquid level height h2(t) is lower than or equal to the lower limit value hₘᵢₙ(t+Δt), the liquid level height h2 remains at the lower limit value hₘᵢₙ(t+Δt) or increases toward the lower limit value hₘᵢₙ(t+Δt) during the predetermined time Δt. That is, the current liquid level height h2(t+Δt) becomes higher than or equal to the last liquid level height h2(t). The amount of fluctuations (the amount of increase) in the liquid level height h2 during the predetermined time Δt is expressed by the second term on the right-hand side in the above-described mathematical expression (6). Because the liquid level height h2(t) is lower than or equal to the lower limit value hₘᵢₙ(t+Δt), the value of the second term on the right-hand side in the above-described mathematical expression (6) becomes 0 or a negative value. According to the above-described mathematical expression (6), the current liquid level height h2(t+Δt) is set so as to be higher than or equal to the last liquid level height h2(t). When the liquid level height h2(t+Δt) becomes higher than the liquid level height h2(t), the point P2 that defines the liquid level height h2 changes in a direction to approach the liquid level of the non-fluctuating electrolytic solution (redundant solution) 130.

In step S205, the controller 40 calculates the amount of fluctuations Δh2(t+Δt). The amount of fluctuations Δh2(t+Δt) is a value obtained by subtracting the last liquid level height h2(t) from the current liquid level height h2(t+Δt). The value calculated in the process of step S203 or step S204 is used as the liquid level height h2(t+Δt).

When the liquid level height h2(t+Δt) is set so as to be lower than the liquid level height h2(t) in the process of step S203, the amount of fluctuations Δh2(t+Δt) becomes a negative value. When the liquid level height, h2(t+Δt) is set so as to be higher than or equal to the liquid level height h2(t) in the process of step S204, the amount of fluctuations Δh2(t+Δt) becomes 0 or a positive value.

In the process of step S203 or step S204, the amount of fluctuations Δh2(t+Δt) has been already calculated. Therefore, in the process of step S205, the amount of fluctuations Δh2(t+Δt), calculated in the process of step S203 or step S204, may be used. The value of the second term on the right-hand side in the above-described mathematical expression (5) or the value of the second term on the right-hand side in the above-described mathematical expression (6) becomes the amount of fluctuations Δh2(t+Δt).

In step S206, the controller 40 calculates the flow rate Vf from the amount of fluctuations Δh2(t+Δt), calculated in the process of step S205. The flow rate Vf can be calculated on the basis of the following mathematical expression (7). As shown in the following mathematical expression (7), the flow rate Vf is calculated at each position (distance d) within the region A in the X direction.

$$Vf ( t + Δ t , d ) = Δ h 2 ( t + Δ t ) \times Vf\_fac \times \frac{d}{L} \qquad ( 7 )$$

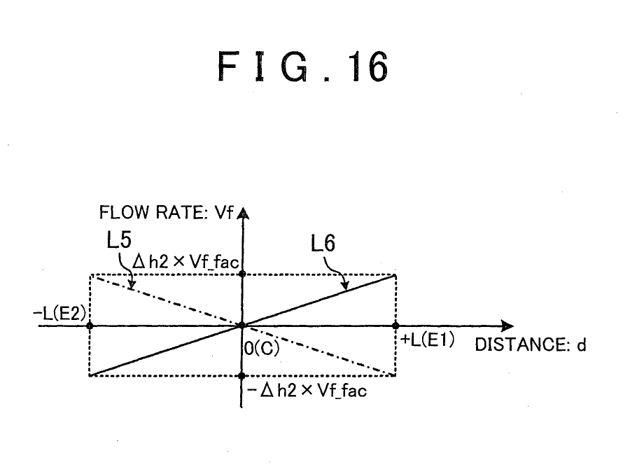

According to the above mathematical expression (7), the correlation between a distance d and a flow rate Vf is the correlation shown in FIG. 16. The straight line (continuous line) L5 shown in FIG. 16 indicates the correlation between a distance d and a flow rate Vf in the case where the amount of fluctuations Δh2(t+Δt) is a negative value. When the distance d is a positive value, the flow rate Vf becomes a negative value; however, the actual flow rate Vf becomes the absolute value of the flow rate (negative value) Vf. Therefore, the straight line L5 shown in FIG. 16 indicates that the flow rate Vf increases as the position approaches from the center portion C to one of the ends E1, E2. When the electrolytic solution 130 moves from the center portion C toward one of the ends E1, E2, that is, when the electrolytic solution 130 moves from the inside of the power generating element 120 toward the outside of the power generating element 120, the liquid level height h2 decreases. Accordingly, the amount of fluctuations Δh2(t+Δt) becomes a negative value. Therefore, the flow rate. Vf in the straight line L5 is a flaw rate at the time when the electrolytic solution 130 moves from the inside of the power generating element 120 toward the outside of the power generating element 120. The moving direction of the electrolytic solution 130 is the X direction.

The straight line (alternate long and short dashed line) L6 shown in FIG. 16 indicates the correlation between a distance d and a flow rate Vf in the case where the amount of fluctuations Δh2(t+Δt) is a positive value. When the distance d is a negative value, the flow rate Vf becomes a negative value; however, the actual flow rate Vf becomes the absolute value of the flow rate (negative value) Vf. Therefore, the straight line L6 shown in FIG. 16 indicates that the flow rate Vf increases as the position approaches from the center portion C to one of the ends E1, E2. When the electrolytic solution 130 moves from one of the ends E1, E2 toward the center portion C, that is, when the electrolytic solution 130 moves from the outside of the power generating element 120 toward the inside of the power generating element 120, the liquid level height h2 increases. Accordingly, the amount of fluctuations Δh2(t+Δt) becomes a positive value. Therefore, the flow rate Vf in the straight line L6 is a flow rate at the time when the electrolytic solution 130 moves from the outside of the power generating element 120 toward the inside of the power generating element 120. The moving direction of the electrolytic solution 130 is the X direction.

As described above, the amount of fluctuations in the electrolytic solution 130 at each of the ends E1, E2 is equal to the amount of fluctuations Δh2(t+Δt) in the electrolytic solution 130 outside the power generating element 120. Thus, the flow rate (absolute value) Vf at each of the ends E1, E2 becomes “Δh2(t+Δt)×Vf_fac”. On the other hand, as the position shifts from one of the ends E1, E2 toward the center portion C, the electrolytic solution 130 becomes difficult to move. Therefore, as indicated by the straight lines L5, L6 in FIG. 16, the flow rate (absolute value) Vf decreases as the position shifts from one of the ends E1, E2 toward the center portion C. The flow rate Vf of the center portion C may be regarded as “0”.

The process of step S207 is the same as the process of step S107. That is, the salt concentration cₑ is calculated on the basis of the above-described mathematical expression (4). Because the flow rate Vf according to the distance d is used as the flow rate Vf, it is possible to calculate the salt concentration cₑ according to the distance d by solving the above-described mathematical expression (4). Thus, it is possible to calculate the salt concentration cₑ according to the position within the region A in the X direction. In other words, it is possible to calculate the distribution of salt concentration cₑ in the X direction.

The process of step S208 is the same as the process of step S108. That is, the difference Δcₑ_{_}max is calculated from the distribution of salt concentration cₑ, and the amount of increase in resistance Dh, corresponding to the difference Δcₑ_{_}max, is calculated.

In the present embodiment, for example, the amount of fluctuations Δh1(t+Δt) is calculated during the predetermined time Δt in consideration of the fact that the liquid level height h1(t+Δt) has not reached the upper limit value hₘₐₓ(t+Δt); however, calculation of the amount of fluctuations Δh1(t+Δt) is not limited to this configuration. For example, each time the current value Ib is detected, the upper limit value hₘₐₓ(t+Δt) corresponding to the detected current value Ib may be regarded as the current liquid level height h1(t+Δt) by using the correlation shown in FIG. 9. In this case, the processes of step S102 to step S104 shown in FIG. 8 are omitted, and the liquid level height h1(t+Δt) may be calculated from the current value Ib.

In the process of step S105 shown in FIG. 8, the current liquid level height h1(t+Δt) becomes the upper limit value hₘₐₓ(t+Δt), and the last liquid level height h1(t) becomes the upper limit value hₘₐₓ(t). Therefore, by subtracting the upper limit value hₘₐₓ(t) from the upper limit value hₘₐₓ(t+Δt), the amount of fluctuations Δh1(t+Δt) is calculated. In this way, it is possible to calculate the amount of fluctuations Δh1(t+Δt) on the basis of the last current value Ib and the present current value Ib. When the upper limit value hₘₐₓ(t+Δt) is identified, not only the current value Ib but also the SOC or temperature Tb of the secondary battery 10 may be considered as described above.

With a similar method, it is possible to calculate the amount of fluctuations Δh2(t+Δt). Specifically, each time the current value Ib is detected, the current liquid level height h2(t+Δt) may be regarded as the lower limit value hₘᵢₙ(t+Δt) corresponding to the detected current value Ib. In this case, the processes of step S202 to step. S204 shown in FIG. 15 are omitted, and the liquid level height h2(t+Δt) may be calculated from the current value Ib.

In the process of step S205 shown in FIG. 15, the current liquid level height h2(t+Δt) becomes the lower limit value hₘᵢₙ(t+Δt), and the last liquid level height h2(t) becomes the lower limit value hₘᵢₙ(t). Therefore, by subtracting the lower limit value hₘᵢₙ(t) from the lower limit value hₘᵢₙ(t+Δt), the amount of fluctuations Δh2(t+Δt) is calculated. In this way, it is possible to calculate the amount of fluctuations Δh2(t+Δt) on the basis of the last current value Ib and the present current value Ib. When the lower limit value hₘᵢₙ(t+Δt) is identified, not only the current value Ib but also the SOC or temperature Tb of the secondary battery 10 may be considered as described above.

By calculating the liquid level height h1(t+Δt) as in the case of the present embodiment, the detailed fluctuations in the liquid level height h1(t+Δt) are easily acquired. Particularly, in charging or discharging the secondary battery 10, when the current value Ib is easy to change, fluctuations in the liquid level height h1(t+Δt) according to a change in the current value Ib are easily acquired. Accordingly, in calculating the distribution of salt concentration cₑ from the liquid level heights h1(t), h1(t+Δt), it is possible to acquire the detailed distribution of salt concentration cₑ. By acquiring the detailed distribution of salt concentration cₑ, it is possible to acquire a detailed change in the amount of increase in resistance Dh.

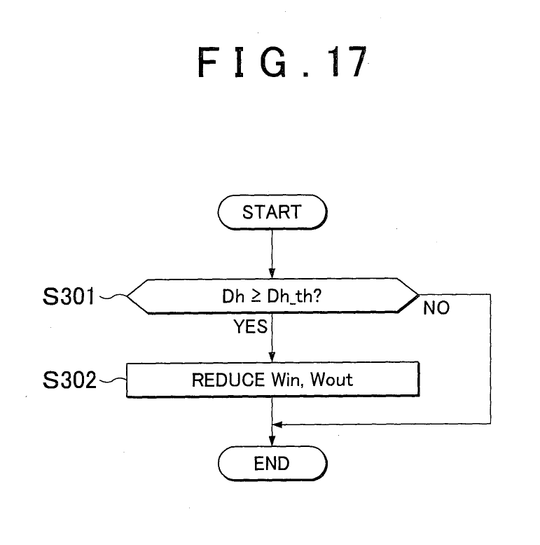

When the amount of increase in resistance Dh is calculated, it is possible to control charging or discharging of the secondary battery 10 on the basis of the amount of increase in resistance Dh. The process (one example) of controlling charging or discharging of the secondary battery 10 will be described with reference to the flowchart shown in FIG. 17. The process shown in FIG. 17 is executed by the controller 40.

In step S301, the controller 40 determines whether the amount of increase in resistance Dh is larger than a threshold Dh_th. The threshold Dh_th is an upper limit value of the amount of increase in resistance Dh, and may be set as needed on the basis of the viewpoint of suppressing degradation of the secondary battery 10. Information that identifies the threshold Dh_th may be stored in the memory 41.

When the amount of increase in resistance Dh is larger than or equal to the threshold Dh_th, the controller 40 decreases an allowable charge power Win or an allowable discharge power Wout in step S302. The allowable charge power Win is an upper limit power at or below which charging of the secondary battery 10 is allowed. The allowable discharge power Wout is an upper limit power at or below which discharging of the secondary battery 10 is allowed.

As described above, because the current value Ib is a negative value when the secondary battery 10 is charged, charge power is also a negative value. When the secondary battery 10 is charged, charging is controlled so that the charge power (absolute value) does not become higher than the allowable charge power (absolute value) Win. When the battery pack 10 is discharged, discharging is controlled so that the discharge power does not become higher than the allowable discharge power Wout.

An allowable charge power Win_ref or an allowable discharge power Wout_ref as a reference value is set on the basis of the temperature Tb or SOC of the secondary battery 10. In the process of step S202, the allowable charge power (absolute value) Win is reduced below the allowable charge power (absolute value) Win_ref, or the allowable discharge power Wout is reduced below the allowable discharge power Wout_ref. By reducing the allowable charge power Win or the allowable discharge power Wout, it is possible to suppress an increase in the amount of increase in resistance Dh.

When the amount of increase in resistance Dh is smaller than the threshold Dh_th, the controller 40 ends the process shown in FIG. 17. At this time, the above-described allowable charge power Win_ref is set as the allowable charge power Win, and the above-described allowable discharge power Wout_ref is set as the allowable discharge power Wout.

Unless a detailed change in the amount of increase in resistance Dh is acquired, there is a concern that the amount of increase in resistance Dh becomes excessively larger than the threshold Dh_th before the allowable charge power Win or the allowable discharge power Wout is reduced in the process of step S302. As described above, when a detailed change in the amount of increase in resistance Dh is acquired, it is possible to reduce the allowable charge power Win or the allowable discharge power Wout before the amount of increase, in resistance Dh becomes excessively larger than the threshold Dh_th.

1. A battery system comprising:
a secondary battery including a power generating element, an electrolytic solution and a battery case, the power generating element being configured to be charged or discharged, the power generating element and the electrolytic solution being accommodated in the battery case;
a current sensor configured to detect a current value of the secondary battery; and
a controller configured to
(a) calculate a liquid level height of the electrolytic solution, the liquid level height indicating a height of a liquid level of the electrolytic solution outside the power generating element with a height from a reference plane to a reference point of the liquid level, the liquid level height being calculated based on the current value that is detected by the current sensor,
(b) calculate a first flow rate, the first flow rate being a flow rate at the time when the electrolytic solution moves from an inside of the power generating element toward an outside of the power generating element, the first flow rate being calculated at each position within the power generating element in a moving direction of the electrolytic solution based on an amount of fluctuations in the liquid level height when the liquid level height fluctuates in a direction in which the reference point moves away from a non-fluctuating liquid level,
(c) calculate a second flow rate, the second flow rate being a flow rate at the time when the electrolytic solution moves from the outside of the power generating element toward the inside of the power generating element, the second flow rate being calculated at each position within the power generating element in the moving direction of the electrolytic solution based on the amount of fluctuations in the liquid level height when the liquid level height fluctuates in a direction in which the reference point approaches the non-fluctuating liquid level,
(d) calculate a distribution of salt concentration on a surface associated with charging or discharging in electrode plates that constitute the power generating element, the distribution of salt concentration being calculated based on the first flow rate at each position, the second flow rate at each position, a diffused state of salt in the electrolytic solution and an amount of salt produced in the electrolytic solution as a result of charging or discharging of the power generating element, and
(e) calculate an amount of increase in resistance of the secondary battery, the amount of increase in resistance being an amount of increase in internal resistance value at the time when the internal resistance value of the secondary battery increases with a bias of salt concentration in the electrolytic solution, the amount of increase in resistance being an amount of increase in resistance corresponding to a maximum difference in the salt concentration, which is identified from the distribution of salt concentration.

2. The battery system according to claim 1, wherein
the controller is configured to calculate a state of charge of the secondary battery, and is configured to calculate the liquid level height based on the state of charge and the current value.

3. The battery system according to claim 2, further comprising:
a temperature sensor configured to detect a temperature of the secondary battery, wherein
the controller is configured to calculate the liquid level height by using at least one of the temperature or the state of charge.

4. The battery system according to claim 1, wherein
the controller is configured to
(a) calculate a second liquid level height, the second liquid level height being a liquid level height that is calculated at intervals of a predetermined time,
(b) calculate the amount of fluctuations by subtracting a first liquid level height from the second liquid level height, the first liquid level height being a liquid level height calculated last time,
(c) when the first liquid level height is calculated, calculate a limit value corresponding to the current value that is detected by the current sensor, the limit value being calculated by using a correlation between the limit value of the first liquid level height and the current value, and
(d) calculate a current liquid level height, the current liquid level height being calculated by adding the amount of fluctuations within the predetermined time in a period until the first liquid level height reaches the limit value, to the first liquid level height.

5. The battery system according to claim 4, wherein
the controller is configured to
(a) acquire information about at least one of a state of charge of the secondary battery or a temperature of the secondary battery, and
(b) calculate the limit value corresponding to the current value that is detected by the current sensor and the acquired information by using a correlation among the current value, the information and the limit value.
